(19) United States
(12) Patent Application Publication
(10) Pub. No.: US 2008/0169617 A1
(43) Pub. Date: Jul. 17, 2008

(54) METHOD OF FORMING A SEALING ELEMENT FOR A BLOW OUT PREVENTER

(75) Inventors: Lyle E. Filliol, Sherwood Park (CA); Kenneth A. Travis, Red Deer (CA)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: STRATA ENERGY SERVICES, Red Deer County (CA)

(21) Appl. No.: 11/971,151

(22) Filed: Jan. 8, 2008

(30) Foreign Application Priority Data
Jan. 12, 2007 (CA) 2575477

(51) Int. Cl. F16J 3/00; E04B 1/682

(52) U.S. Cl. 277/636; 277/316

(57) ABSTRACT

A method of forming a sealing element for a blowout preventer, and a sealing element. A first step involves providing a conical mould having more than one part consisting of an inner mandrel adapted to shape an interior sidewall of a sealing element and an outer mould adapted to shape an exterior sidewall of the sealing element. A second step involves saturating wear resistance fabric with liquid polymer, the liquid polymer being suitable for use as a resilient sealing element when set. A third step involves covering the inner mandrel with the saturated fabric. A fourth step involves assembling the conical mould. A fifth step involves pouring liquid polymer into the mould and allowing the liquid polymer to set, thereby forming the sealing element with the wear resistant fabric embedded in the interior sidewall. A sixth step involves removing the sealing element from the conical mould.

### FIELD

The present application relates to a method of forming a sealing element for a blow out preventer and a sealing element for a blow out preventer formed in accordance with the teachings of the method.

### BACKGROUND

Sealing elements are commonly used in conjunction with blow out preventers to control the returns and blow by from the well bore. Canadian Patent Application No. 2,460,503 describes a sealing element for use with a blow out preventer.

### SUMMARY

There is provided a method of forming a sealing element for a blowout preventer, and a sealing element. A first step involves providing a conical mould having more than one part consisting of an inner mandrel adapted to shape an interior sidewall of a sealing element and an outer mould adapted to shape an exterior sidewall of the sealing element. A second step involves saturating wear resistance fabric with liquid polymer, the liquid polymer being suitable for use as a resilient sealing element when set. A third step involves covering the inner mandrel with the saturated fabric. A fourth step involves assembling the conical mould. A fifth step involves pouring liquid polymer into the mould and allowing the liquid polymer to set, thereby forming the sealing element with the wear resistant fabric embedded in the interior sidewall. A sixth step involves removing the sealing element from the conical mould.

### BRIEF DESCRIPTION OF THE DRAWINGS

These and other features will become more apparent from the following description in which reference is made to the appended drawings, the drawings are for the purpose of illustration only and are not intended to be in any way limiting, wherein:

FIG. 1 is a side view in section of a sealing element.

FIG. 2 is a perspective view of the sealing element shown in FIG. 1.

FIG. 3 is a side view in section of a conical mould.

FIG. 4 is a side view of an inner component of the conical mould being covered with a sleeve of wear resistant material.

FIG. 5 is a side view of an inner component of the conical mould being covered with strips of wear resistant material.

FIG. 6 is a side view in section of the conical mould being used to form a sealing element.

FIG. 7 is a side view in section of the conical mould being used to form a sealing element with a base and embedded springs.

### DETAILED DESCRIPTION

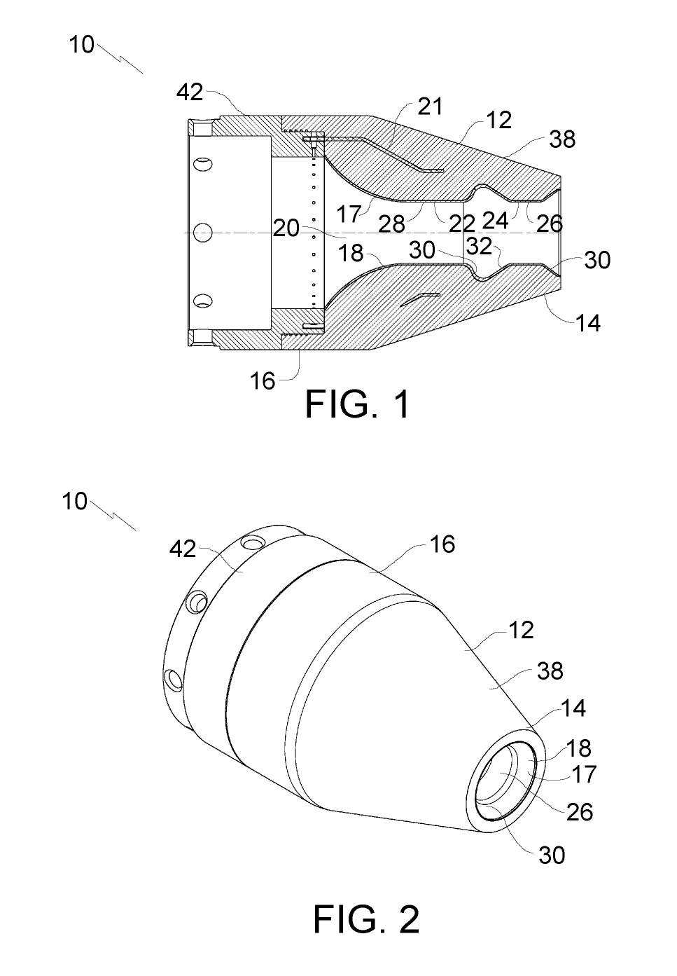

A sealing element generally identified by reference numeral 10, will now be described with reference to FIGS. 1 and 2.

Structure and Relationship of Parts:

Referring to FIG. 1, sealing element 10, intended for use with a blowout preventer (not shown), includes a resilient polymer body 12 having a generally conical-shape. Beneficial results have been obtained using urethane, but it will be understood that many different polymers might also be used, including naturally occurring materials, such as natural rubber. Body has a first end 14, a second end 16 and an interior sidewall 18 defining a central flow passage 20 that extends from first end 14 to second end 16. A wear resistant liner 17 is embedded in interior sidewall 18 of resilient body 12. A suitable material for wear resistant liner 17 is aramid fiber, commercially know as KEVLAR™. As will hereinafter be further described in relation to the method, wear resistant liner 17 may be in the form of a sleeve of wear resistant fabric, or a wrap of wear resistant fabric. It is preferred that a spring element 21 be integrally moulded into the interior sidewall.

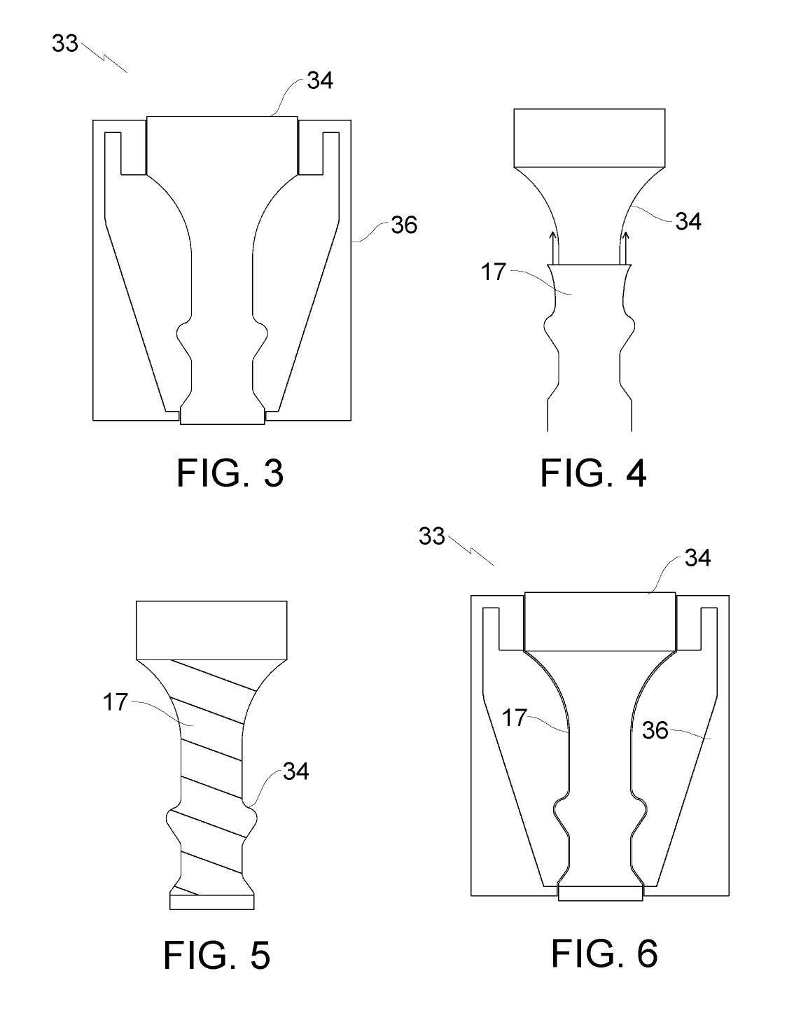

A method of forming sealing element 10 will now be described with reference to FIG. 3 through 7.

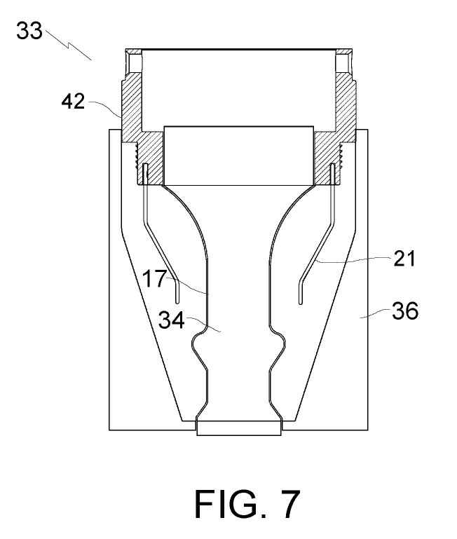

Referring to FIG. 3, a two part conical mould 33 consisting of an inner mandrel 34 adapted to shape interior sidewall 18 of sealing element 10 and an outer mould 36 adapted to shape an exterior sidewall 38 of sealing element 10 is shown. While mould 33 is described as a two part mould for simplicity, it will be understood that either inner mandrel 34, or more commonly, outer mould 36 of mould 33 may be a multi-part conical mould, with the actual number of parts increasing with the size of the element that is produced. Referring to FIG. 4, wear resistant fabric 17 that has been saturated with a liquid polymer is used to cover inner mandrel 34. In this embodiment, saturated fabric 17 is in the form of a sleeve that is stretched over inner mandrel 34. Referring to FIG. 5, other options include wrapping saturated fabric 17 around inner mandrel 34 using strips as shown. However, a larger sheet may also be used to wrap inner mandrel 34. When wrapping, the saturated fabric may be overlapped to allow for expansion and contraction of material. Referring to FIG. 6, once inner mandrel 34 is wrapped, mould 33 is reassembled, and liquid polymer 40, such as liquid urethane, is poured into mould 33. Liquid polymer 40 is allowed to set in order to form sealing element 10 with wear resistant fabric 17 embedded in interior sidewall 18 as shown in FIGS. 1 and 2. Once the polymer has set, sealing element 10 is removed from mould 33. Referring to FIG. 7, a base 42 may be inserted into mould 33 in order to have it attached to one end of sealing element 10. Spring 21 is attached to base 42 and is therefore inserted at the same time. Base 42 and spring 21 may be inserted into the mould before liquid polymer is injected, or before the liquid polymer sets. As can be seen, mould 33 may need to be modified slightly to allow for this. It will be understood that modifications may be made if only one or the other of base 42 and spring 21 are desired.

Advantages:

The above described sealing element provides a wear resistant surface within the sealing element. This is useful in circumstances when there are sharp corners on “Drilling Kellys” (such as hex or square Kellys) that can cause cuts or grooves on the internal sealing surface of the sealing element, or rough edges on drill pipe collars and joints that may also cause excessive wear and pitting on the internal sealing surface of the element. Without the wear resistant surface, these grooves and pits may allow passage for fluids when the Kelly is removed and the element is sealing on the round drill pipe.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

It will be apparent to one skilled in the art that modifications may be made to the illustrated embodiment without departing from the spirit and scope defined in the Claims.

What is claimed is:

1. A method of forming a sealing element for a blowout preventer, comprising the steps of:
providing a conical mould having more than one part, the conical mould consisting of an inner mandrel adapted to shape an interior sidewall of a sealing element and an outer mould adapted to shape an exterior sidewall of the sealing element;
saturating wear resistance fabric with liquid polymer, the liquid polymer being suitable for use as a resilient sealing element when set;
covering the inner mandrel with the saturated fabric;
assembling the conical mould;
pouring liquid polymer into the mould and allowing the liquid polymer to set, thereby forming the sealing element with the wear resistant fabric embedded in the interior sidewall;
removing the sealing element from the conical mould.

2. The method as defined in claim 1, the liquid polymer being liquid urethane.

3. The method as defined in claim 1, the liquid polymer being natural rubber.

4. The method as defined in claim 1, the wear resistance fabric being aramid fiber.

5. The method as defined in claim 1, the step of covering the inner mandrel with the saturated fabric being performed by stretching a sleeve of the saturated fabric over the inner mandrel.

6. The method as defined in claim 1, the step of covering the inner mandrel with the saturated fabric being performed by wrapping the saturated fabric around the inner mandrel.

7. The method as defined in claim 6, one or more strips of fabric being wrapped around the inner mandrel, with individual wraps of the saturated fabric being overlapped to allow for expansion and contraction.

8. The method as defined in claim 1, wherein at least one of the outer mould and the inner mandrel is made from more than part.

9. A sealing element for a blowout preventer, comprising:
a resilient polymer body having a generally conical-shape, the body having a first end, a second end and an interior sidewall defining a central flow passage that extends from the first end to the second end, the second end being larger in diameter than the first end;
the interior sidewall having annular projections defining at least one annular seal;
a wear resistant liner lining embedded in the interior sidewall of the resilient body.

10. The sealing element as defined in claim 9, wherein a spring element is integrally moulded into the interior sidewall.

11. The sealing element as defined in claim 9, wherein the wear resistant liner is aramid fiber.

12. The sealing element as defined in claim 9, wherein the polymer is urethane.

13. The sealing element as defined in claim 9, wherein the polymer is natural rubber.

14. The sealing element as defined in claim 9, wherein the wear resistant liner is one of: a sleeve of wear resistant fabric, or wrap of wear resistant fabric.
